(19) United States
(12) Patent Application Publication
(10) Pub. No.: US 2010/0063837 A1
(43) Pub. Date: Mar. 11, 2010

(54) Web-based wellness process

(76) Inventors: Justin J. Bellante, Santa Barbara, CA (US); Raja V. Jindal, Santa Barbara, CA (US); David M. Torres, Santa Monica, CA (US); Timothy D. Wisleder, Springfield, IL (US)

Correspondence Address: MARK RODGERS, 1590 SAN ROQUE ROAD, SANTA BARBARA, CA, 93105, US

(21) Appl. No.: 12/283,432

(22) Filed: Sep. 10, 2008

(51) Int. Cl. G06Q 50/00; G06Q 30/00; G06Q 10/00

(52) U.S. Cl. 705/2; 705/26; 705/9

(57) ABSTRACT

The invention is a process to encourage and simplify preventive medical practices. The process includes selecting known effective in-home medical test kits from laboratories and making these kits available to users for order through a website. The fulfillment of the orders from the labs as well as the collection of the results is coordinated. The results are consolidated with appropriate analysis into a report which is made available to the user through the website on a restricted basis, such as password control. The process may optionally include a health risk assessment questionnaire which guides the user in test kit selection. The process can be initiated by an employer in the form of an invitation to an employee to participate, and the website can be customized and co-branded with the employer.

### BACKGROUND OF THE INVENTION

The invention relates to wellness, and in particular to in-home medical evaluation and a process for simplifying and encouraging in-home medical assessment.

Many people are at risk for contracting life-threatening diseases such as diabetes, cancer, osteoporosis and heart disease. In the United States in particular, obesity is at an alarmingly high level, and the population over 55 is increasing both in absolute numbers and as a percentage of the entire population. These people, and many others, are often at risk and need preventive measures to help them change habits which may lead to disease, or to detect threatening conditions early enough to allow for more effective, less elaborate and expensive treatment. Approximately 95 percent of the money the US currently spends on health care goes to medical services, while only 5 percent is allocated to preventing diseases and promoting health. Improved preventive care would greatly decrease overall medical costs, thereby leading to lower medical insurance costs and other costs associated with chronic conditions, such as loss in productivity, absenteeism, and presenteeism. In particular, corporations who pay for employees' medical insurance would benefit greatly from their employees' improved preventive medical practices. Costs can similarly be decreased by more effectively monitoring and managing known, existing diseases and conditions.

Over the past several years, effective in-home self-administered tests have become available for a variety of conditions, such as Diabetes, Cardiovascular Disease, Kidney Disease, Colorectal Cancer, Prostate Cancer, Thyroid Disorder and Osteoporosis, among others. Systematic and organized use of these tests would constitute improved preventive medicine, benefiting both users and their employers. These tests are readily available, and in fact can be ordered from the internet, taken by the user, and the kits are typically returned to the labs in provided self-addressed mailers. Yet for all of the apparent availability, wide-spread adoption of these home tests by a full spectrum of those at risk has been minimal. Widespread adoption of home testing by health care and wellness providers, insurers, and other entities has also been minimal.

There are several reasons for this situation. First, not all laboratories providing test kits are equally proficient at all tests, so a user has little idea if any particular test kit is, in fact, effective. Secondly, no one wants to take every available test, but most people do not have a clear idea of where they are most at risk and therefore most needing of a particular test. Thirdly, there is often a reluctance to actively seek out medical information, particularly if that information may be unpleasant and frightening. Fourthly, although the test results from the home tests are made available to a user, there is no current process that collects the results from the various tests with the user's own habits and risk factors into a consolidated, easy-to-understand set of reports that considers all of the variables simultaneously. Finally, the results from existing home tests are not necessarily easily accessible or presented in the context of other current or past test results.

Therefore it is the object of this invention to provide a process, whereby a user acquires home medical tests based on their particular risk situation, and that the tests are selected by type, with the providing laboratory chosen by the process as one of known effectiveness for a particular test. It is a further object of this invention to deliver consolidated reports including test results and known risk factors. It is a further object of this invention that the process in preferred embodiments be web-based. It is another object of this invention to include an employer as an active participant in the process. It is another object of this invention to include other health care services such as, but not limited to, health coaches or other health and wellness interventions as participants in the process.

### BRIEF SUMMARY OF THE INVENTION

The invention is a process, including the steps of accessing a website by a user, wherein the user provides information to the website, thereby generating an order for a selection of home medical tests kits, fulfilling the test kit order with test media coming from laboratories or manufacturers with known acceptable quality for the particular test, coordinating test kit shipment to the user, consolidating the results from all tests into a user account, and making the account accessible on the website on a user-restricted basis. The user can request paper-based lab reports and assessment feedback as well. In one embodiment, the user-provided information is selecting test kits from a list thereby generating the test kit order. In an alternative embodiment, the user-provided information is in the form of a health risk assessment, whereby the user answers health-risk questions. The test kit order may be generated based on the results of the health risk assessment. In some versions, the laboratory media is acquired from each laboratory or component manufacturer and packaged into a test kit at a fulfillment center. In a preferred embodiment, the media is identified by barcode only, thereby protecting user privacy.

The results, either anonymously or not, may be made available to employers or other third parties. The user in preferred embodiments will control access to results. In some versions, anonymous results may be made available for statistical purposes. In preferred embodiments, the test results will be consolidated with the health risk assessment. A schedule for future testing may be generated based on the consolidated information.

In other embodiments, the process may be part of an employer's company wellness program. The process may be initiated by sending an invitation from the system or the user's employer to the user inviting the user to access and use the website. The website may be co-branded to identify the employer and communicate an employer's messages to users. The website may be customized to the employer's specific requirements as to which tests are available, and/or which questions are asked on the health risk assessment if the assessment is used. In some cases, for an employer wellness program, not all employees may have web access, so communication to enter the process and receive results may have to be by mail or telephone.

### BRIEF DESCRIPTION OF THE DRAWINGS

The invention will be better understood by referring to the following figures.

FIG. 1 depicts the main elements of the novel process

FIG. 2 depicts the process with the Health Risk Analysis

FIG. 3 depicts the process applied to wellness of employees in a corporation

### DETAILED DESCRIPTION OF THE INVENTION

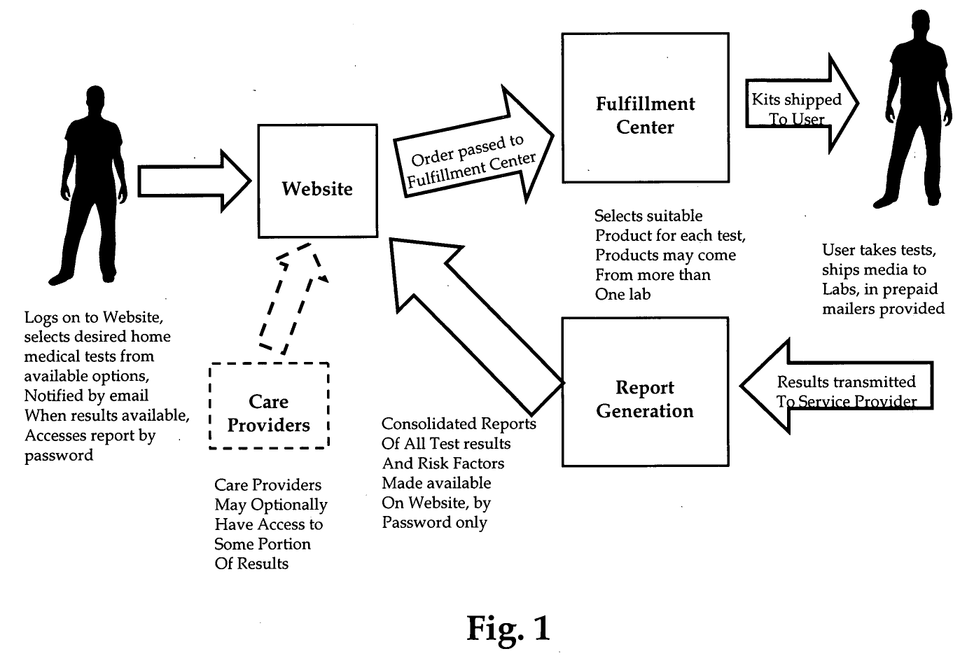

Turning to FIG. 1, the novel practice is described. A user shown in black logs on to a wellness website, provided by the process service provider. For purposes of this disclosure, service provider will take the meaning of the provider of the novel process, and is not to be confused with medical or insurance providers. The website presents a list of types of medical tests that can be performed at home. In the simplest embodiment, the user directly chooses a set of tests based on his own criteria.

An important aspect of the process is that the tests selected by the user are individually fulfilled by the service provider for analysis by laboratories that the provider knows are proficient for the test. In theory each test in any given order could come from a different laboratory, if that is necessary to ensure that all tests are high quality and that the testing process is efficient and timely. Thus the user only has to select type of test and choice of laboratory is preferably transparent to the user. Laboratories may also be chosen based on other factors such as geographical location. Unlike other home testing solutions currently available, individual tests are procured from the most advantageous source.

The service provider fulfillment center coordinates delivery of the tests, from possibly multiple sources to the user. The user self-administers the tests or completes them with the aid of another individual and returns the test kit or more typically just the test media (vial, sample collection device, description of results, etc.) to the associated lab, again preferably in a transparent manner such as a provided self-addressed mailer, so the user only has to order, take the test and put individual test samples in the mail. The samples are then routed by the provider to the appropriate laboratories with known acceptable quality for each particular test. In a preferred embodiment, the process service provider only acquires the media from the various laboratories and component manufacturers, and packages up the kits at an assembly and fulfillment center. In this case, all test kits have a consistent look and feel unique to the service provider, and since return shipping materials are provided, the potentially different origins and destinations of the test kits are transparent to the user. Once the samples have been analyzed, the test results are preferably electronically uploaded to the service provider and the user is preferably notified via email but possibly by receiving a hardcopy of their lab report in the mail. The results from all tests and assessments are then prepared into a single report or set of reports, and health analysis reports and online interfaces are generated based on the consolidated results. In a preferred embodiment, a user's progress throughout the process is monitored by the service provider, and an automated set of reminders and communications are sent to the user, preferably via email, according to a pre-set or customized schedule, to ensure that a user finishes all steps involved in the testing and/or follow-up processes to testing. Additionally, an automated series of communications could be directed at users, preferably via email, in order to increase the number of users who start or participate in the testing process.

The test results do not go directly from lab to user as is currently the case. Instead the results go directly to the process service provider. The service provider performs an additional service of consolidating and elaborating on the test results, along with any indicated risk or danger notifications, into a user account, which preferably is easier to understand and use by the user. The report could be conventionally mailed or conveyed over the phone; email of such information is unlawful, but is preferably made available on the website through some user-restricted means. One commonly used means is to set-up a password-secured account when the user signs up for the service, and make the report available when the user is logged on to his or her account. The user could be notified via email, mail and/or phone to log into their secured account to see their results.

An optional part of the process is to allow medical care providers, employers, wellness vendors, or other parties involved in the health and wellness of users access to some part of the results or a summary of results with or without user permission. One way this could be accomplished is by populating a health record, health analysis, health decision, health management, or other tools employed by a medical care provider with data that may be obtained from the user or the user account. In a preferred embodiment, test media is identified by barcode only, thereby insuring user privacy.

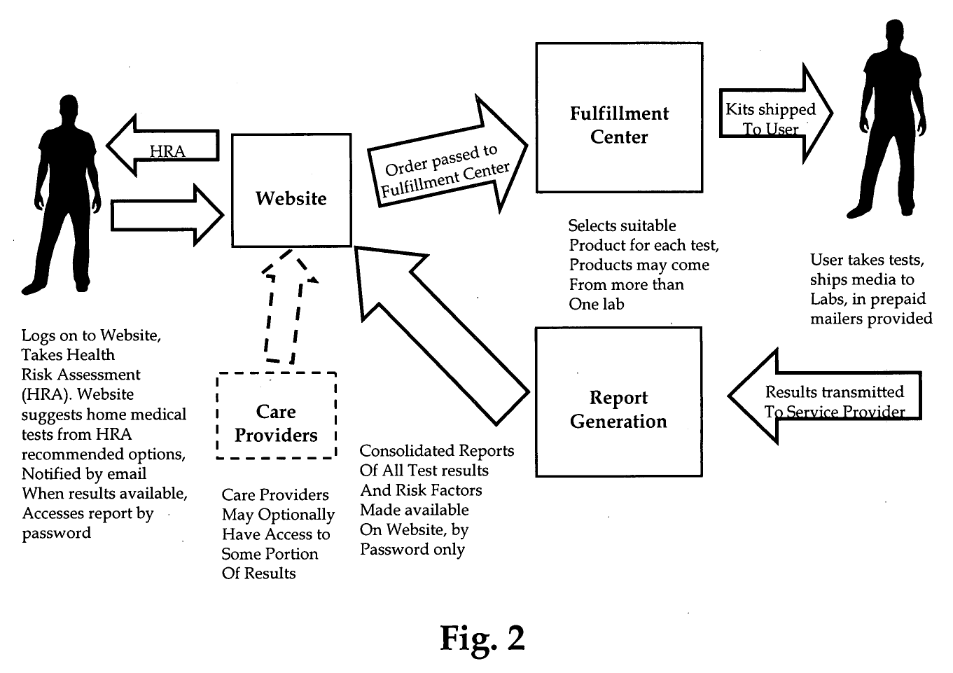

Turning to FIG. 2, the process may be enhanced by the website providing a pre-analysis of the users needs before selecting an order of test kits. In this embodiment, a user would answer a Health Risk Assessment (HRA) questionnaire, providing information such as age, weight, personal habits and family history, which the service provider can use to recommend to the user a selected group of test kits which directly pertain to risk factors and life style choices determined by the analysis. In another embodiment a user could provide other health data or records that could be used to recommend tests. Such data could come from genetic test information, eligibility information from a health care provider or plan, or other health data that could be inputted or imported. Preferably, the reports which indicate the test results also reference and include information from the risk analysis, where appropriate. For the desired case where a user repeats the process on an annual or other basis, the results can be displayed to portray how they have changed over time. Furthermore, based on the consolidated risk assessment/test results or other inputted health data, a recommended schedule of repeat testing may be generated, and the user may be informed, preferably by email, when it is recommended to perform tests. In another embodiment, the user may subscribe to a recommended testing schedule and receive test kits automatically at pre-determined intervals. The user may also be directed to specific content, books, medical articles or the like, based on the results and assessment.

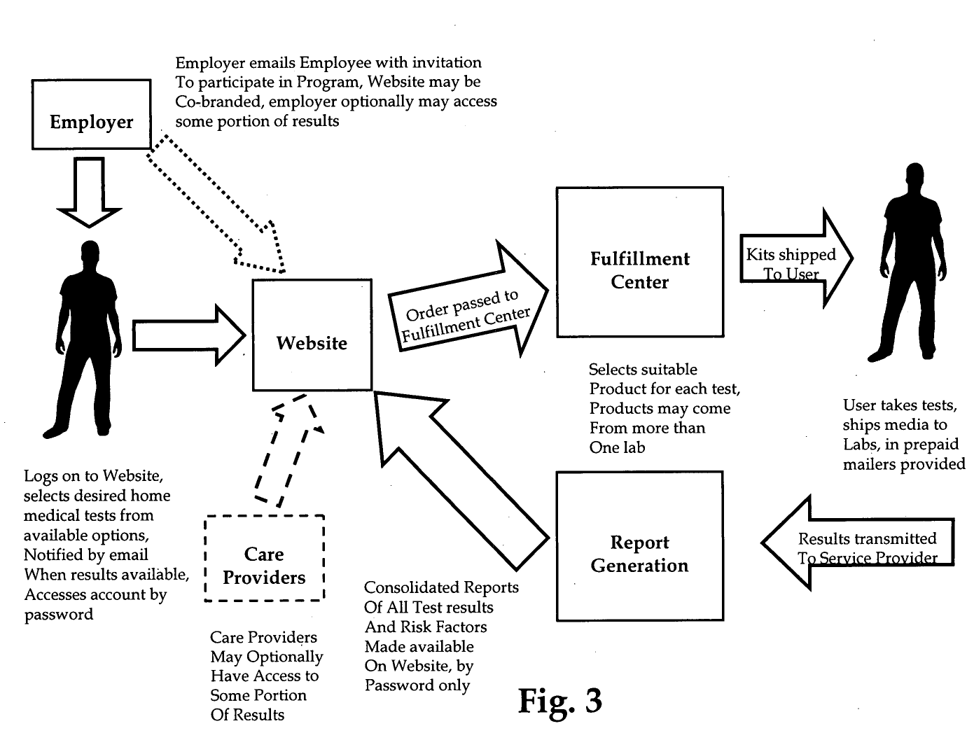

FIG. 3 shows an embodiment of the invention aimed at employers who wish to encourage the employees to engage in preventive practices with the aim of reducing corporate medical insurance rates, reducing general healthcare costs, and/or improving employee productivity and health. In this embodiment, employees are sent invitations to participate in the process. Thus the entry point into the process is the user receiving the notice or actual test kit from his employer or medical provider (which could actually be sent out from the service provider in the employer's name and thus tracked by the service provider). Preferably, the employer, health plan, health insurer, or group of marketing entities pays for or subsidizes the service and/or offers additional incentives to further encourage the employee to participate. A separate customized version of the wellness website, which only employees can access may be set-up. This web-site can be co-branded with the employer's information and any particular messaging the employer wants to get across. Also the web-site may be customized to provide exactly the services the particular employer desires its employees to receive, such as a subset of the test list for example, and/or a subset of the risk assessment. The web-site may be customized to integrate with, or co-brand with, other wellness or health services from partners, health coaches or third-party vendors. Additionally, in most cases the individual's test results would not be made available to the employer directly, but it is anticipated that the employer may receive some or all of the results on an anonymous (de-identified), aggregated basis to gather health statistics for the company as a whole.

For the case where the process is used to facilitate wellness within a corporation, the process may have to be modified to allow access to the full spectrum of the corporation's employees and/or dependents. It is common for employees of large corporations to come from a variety of educational and economic backgrounds, and therefore not all employees may have web access. For this case, the internal sections of the process may be utilized, but the entry points and data output points require modification. Employees will have to be contacted by mail or telephone. For the case where an HRA is not used, the employer's selected program may be sent directly to the employee with explanatory materials. The HRA may still be used, either as a written questionnaire or telephone interview. The test fulfillment and results acquisition by the service provider may proceed as in the web-based case. The consolidated reports and results integration with the HRA may also proceed as in the full-featured scenario. Results communication with the employee may either be direct by mail, or some combination of telephone consultation and mail. Results reporting to medical care and to the corporation may proceed as in the web-based process. It would also be possible to have employees' results be communicated by wellness program representatives in person, possibly at the work place, but such a system is not preferable for privacy concerns. In cases where other non-at-home screening or testing services are employed, the web-site may be customized to integrate with these services and reporting, and data may be combined from at-home testing, the web site application, and other services for reporting to the employer or user.

Test result data, such as data that may be obtained according to the processes above, can help activate or improve other health care processes when it is shared with or exported to programs, databases, or electronic systems. Test result data may be used to automatically populate the database or web application tools of the service provider. Test result data may be used to automatically populate online risk assessments, medical records, or medical programs of the service provider or other medical or wellness parties involved in the health care of a user such as a health coach. A user may also choose to have test results exported to a third party or a separate health record.

Test result data, such as data that may be obtained according to the processes above, may be used to populate an interface used for follow-up contact by an external call-center or third-party specifically for the purpose of health/wellness coaching and education.

For the case where the process is used to facilitate wellness within a corporation, the employer, a health consultant, or a health plan employee made be provided with an interface to track the wellness program progress, participation, and aggregated results and information. This may help improve or optimize the wellness program.

We claim:

1. a process, comprising;
accessing a website by a user, wherein the user provides information to the website, thereby generating an order for a selection of home medical tests kits,
fulfilling the test kit order with test media coming from laboratories or manufacturers with known acceptable quality for the particular test,
coordinating test kit shipment to the user,
consolidating the results from all tests into a user account; and,
making the account accessible on the website on a user-restricted basis.

2. The process of claim 1 wherein user provided information is used to select test kits from a list thereby generating the test kit order.

3. The process of claim 1 wherein;
The user provided information is in the form of a health risk assessment, whereby the user answers health-risk questions.

4. The process of claim 3 wherein the test kit order is generated based on the results of the health risk assessment.

5. The process of claim 1 wherein the laboratory test media is acquired from each laboratory and/or component manufacturer, and packaged into a test kit by a fulfillment center.

6. The process of claim 1 further comprising;
making at least one of all results, a portion of the results, or a summary of results available to a third party.

7. The process of claim 1 further comprising;
sending an invitation from the user's employer to the user inviting the user to access and use the website.

8. The process of claim 7 wherein the website is co-branded to identify the employer and communicate an employer's messaging to users.

9. The process of claim 8 wherein the website is customized to the employer's specific requirements as to which tests are available.

10. The process of claim 3 further comprising;
sending an invitation from the user's employer to the user inviting the user to access and use the website.

11. The process of claim 10 wherein the website is co-branded to identify the employer and communicate an employer's messaging to users.

12. The process of claim 11 wherein the website is customized to the employers specific requirements as to which tests are available and which questions are asked in the health risk assessment.

13. The process of claim 7 further comprising;
making at least one of all results, a portion of the results, or a summary of results available to the employer on an anonymous basis.

14. The process of claim 3 further comprising;
consolidating the test results with the health risk assessment.

15. The process of claim 14 further comprising;
generating a schedule of future home testing based on the test results and/or the health risk assessment.

16. The process of claim 1 wherein test media for all tests is identified by barcode only, thereby protecting user privacy.

17. a process, comprising;
Obtaining a list of employees from an employer for participation in a corporate wellness program,
communicating with at least a portion of the listed employees,
determining an order for in-home medical test kits for at least a portion of the employees on the list,
fulfilling the test kit order with test media coming from laboratories or manufacturers with known acceptable quality for the particular test,
coordinating test kit shipment to the employee,
consolidating the results from all tests into an employee report; and,
communicating the report to the employee.

18. The process of claim 17 further wherein the communicating steps with the employee are accomplished by at least one of:
mail,
telephone; or
email.

19. The process of claim 17 wherein the determining step comprises at least one of;
basing the order on the employer's pre-selected test kit list, or
providing the employee a menu of available test kits and allowing the employee to choose which tests to order.

20. The process of claim 17 further comprising;
providing an employee with a health risk assessment.

21. The process of claim 20 wherein the determining step comprises basing the test kit order at least in part on the results of the health risk assessment.

22. The process of claim 20 wherein the test results are consolidated with the health risk assessment.
